(19) United States
(12) Patent Application Publication
(10) Pub. No.: US 2010/0326544 A1
(43) Pub. Date: Dec. 30, 2010

(54) Shock responsive check valve

(76) Inventor: John Ernest Elwart, Playa Del Rey, CA (US)

Correspondence Address: John Ernest Elwart, P.O. Box 5342, Playa Del Rey, CA, 90296, US

(21) Appl. No.: 12/459,280

(22) Filed: Jun. 29, 2009

(51) Int. Cl. F16K 15/03

(52) U.S. Cl. 137/527

(57) ABSTRACT

This disclosure is directed to an earthquake or shock responsive swing check valve, shutting off water in an earthquake. The device utilizes a common swing check valve whereby the internal parts are machined and retrofitted to be responsive to shock. The reacting parts are the valve door and a magnet. Thus the valve door is provided with a circular steel plate fastened connectably to the door. The magnet is positioned outside the valve and above the valve door, making a magnetic attraction between valve door and magnet, thereby keeping the valve door in open position. Upon a shock or earthquake, the magnetic attraction between the door and magnet is broken, shutting off the water supply. The device can be reset to open position with a simple screwdriver.

### FIELD OF THE INVENTION

The present invention relates to a device that is commonly known as a swing check valve used mainly to stop the flow of water stored in pipes to prevent the water from draining out of a pipe, thereby facilitating plumbing repairs without the need to drain the entire pipeline. In particular, the present invention uses a swing check valve connected to the plumbing in reverse to shut off water in an earthquake. Briefly, the present invention uses a standard swing check valve by adding a steel circular plate mounted connectably to the upper top of the valve door and a magnet fastened above the outer body of the valve which is positioned directly above the steel circular plate. The magnetic attraction between the circular steel plate and the magnet keep the valve door open so water can flow through the valve unobstructed. The door on the swing check valve has been machined with a grinder to enable the valve door to rise higher in elevation than it was intended by the manufacturer, thereby to enable a full flow of water in which the entire inside of the valve body is unobstructed. Thus, the swing check valve is fastened to the water supply in the reverse position so that the valve door is facing the water flow and pressure. Since the valve door is elevated higher than the flow of water, and the door is magnetically attracted to the magnet on the upper outside of the valve body, the door can only close when the occurence of shock or earthquake breaks the contact.

### SUMMARY OF THE INVENTION

In accordance with the present invention there is provided a device to stop the flow of water in an earthquake or violent shock. The device is a swing check valve which has been machined and retrofitted to react in an earthquake. The swing check valve in this instance, is connected to the water supply in reverse direction. Additional parts added to this valve include a magnet, a steel valve door cover, to attract the valve door to the magnet which is positioned outside the valve directly above the valve door. Also added parts include a retaining pin inserted into valve door hinge pin and inserted into the valve door swing frame body, together with a screwdriver straight slot machined into the hinge pin to enable the resetting of the device with a counterclockwise turn of a screwdriver. Additionally, the hinge pin has been machined to supply an o ring to provide a water tight seal since the nut connector that usually seals the hinge pin is no longer used.

In operation, the fluid flow of water enters the swing check valve which is connected to the plumbing in reverse position. The fluid passes through the opening of the valve body and enters the rest of the plumbing pipes. Upon shock or earthquake, the magnetic attraction between the valve door and the magnet is broken, thus causing the valve to reside in the annular valve seat.

### BRIEF DESCRIPTION OF THE DRAWINGS

FIG. 1 shows a perspective view of the present invention illustrating the check valve door in open position.

FIG. 2 shows the present invention with the check valve door in the closed position.

FIG. 3 shows an exploded view of check valve door, its corresponding parts and a view of a part of check valve door lever arm that has been machined out and removed to make door rise higher.

FIG. 4 shows an exploded view of the check valve door, the hinge pin assembly together with retaining pin, screw slot and O-ring.

### DETAILED DESCRIPTION OF THE INVENTION

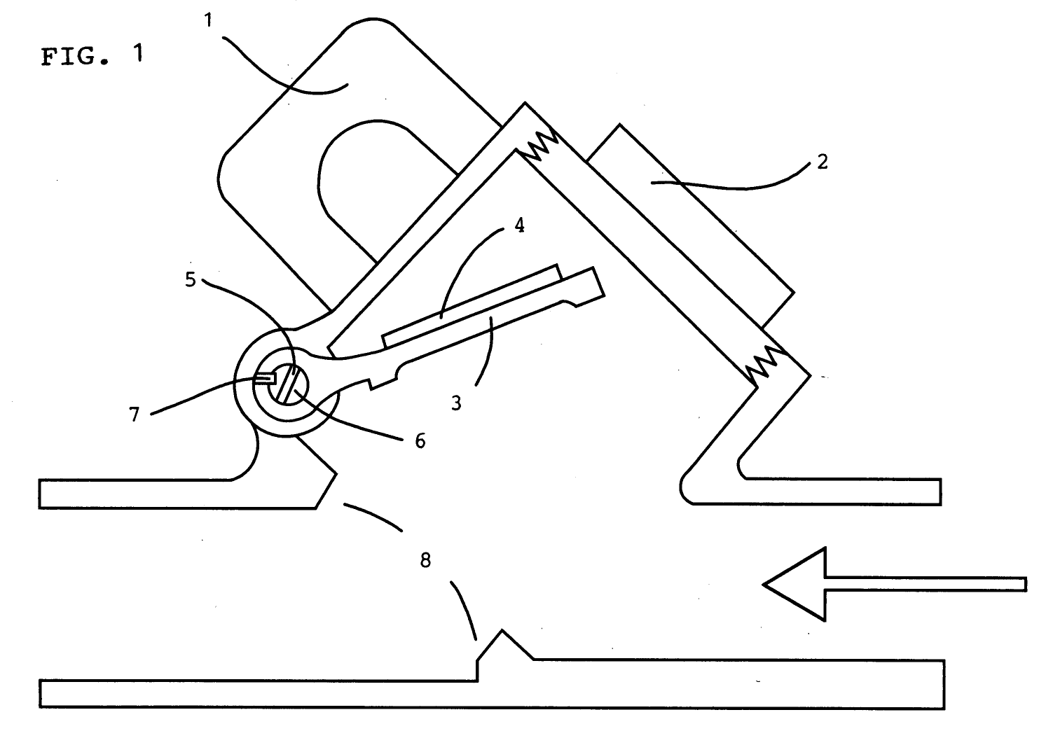

Referring to FIG. 1, the check valve of the present invention shows the valve door in the open position. Magnet 1, is on top of the valve body which attracts the steel door cover 4, to keep the door in open position by magnetic attraction between 1 and 4. Valve door 3, is the shock responding part which closes against annular valve seat 8 when shock or earthquake releases the magnetic attraction between 1 and 4. Hinge pin 6 supports the valve door and enables its movement. To enable a screwdriver to reset the valve door after it trips, retaining pin 7 is machined part distance into hinge pin thereby enabling the door to move upwardly by the use of screwdriver slot 5 engagably with a straight slot screwdriver to turn anticlockwise and return the valve door upwardly in elevation toward magnet 1, thereby opening the water supply. Valve cap 2 seals the unit and all functions of the valve and magnet can be inspected with the cap unscrewed.

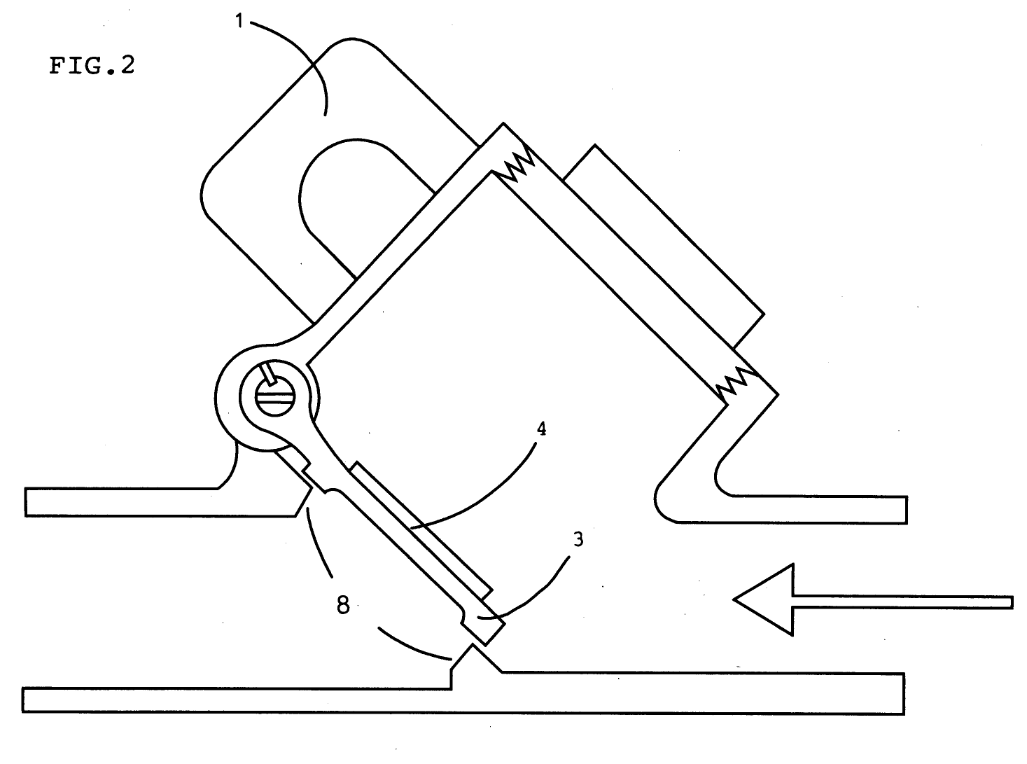

Referring to FIG. 2, the check valve of the present invention shows the valve in the closed position. Valve door 3 is seated to annular valve seat 8. The magnetic attraction between magnet 1 and steel door cover 4 is broken.

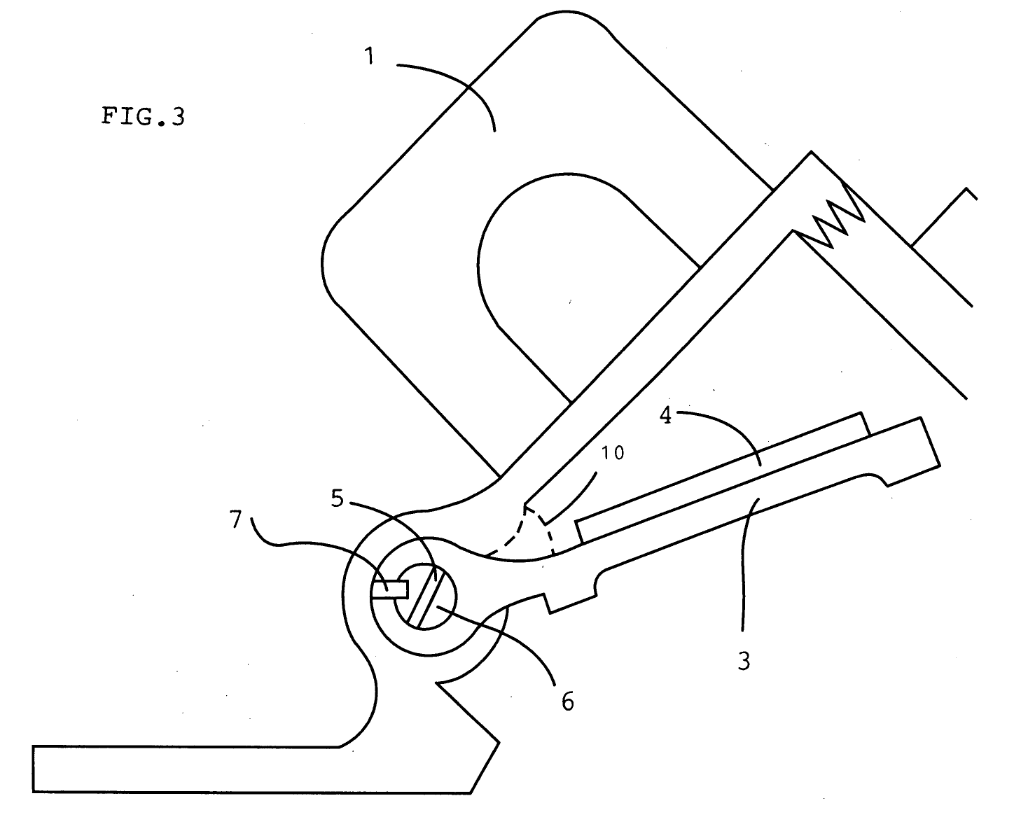

Referring to FIG. 3, the check valve of the present invention shows an exploded view of magnet 1, valve door 3, steel door cover 4, and 5, 6, and 7; the corresponding hinge parts. Original manufacturers door stopper 10 is shown with broken lines since it was machined out to enable valve door 3 and steel door cover 4 to rise higher in elevation to increase magnetic attraction between 4 and magnet 1.

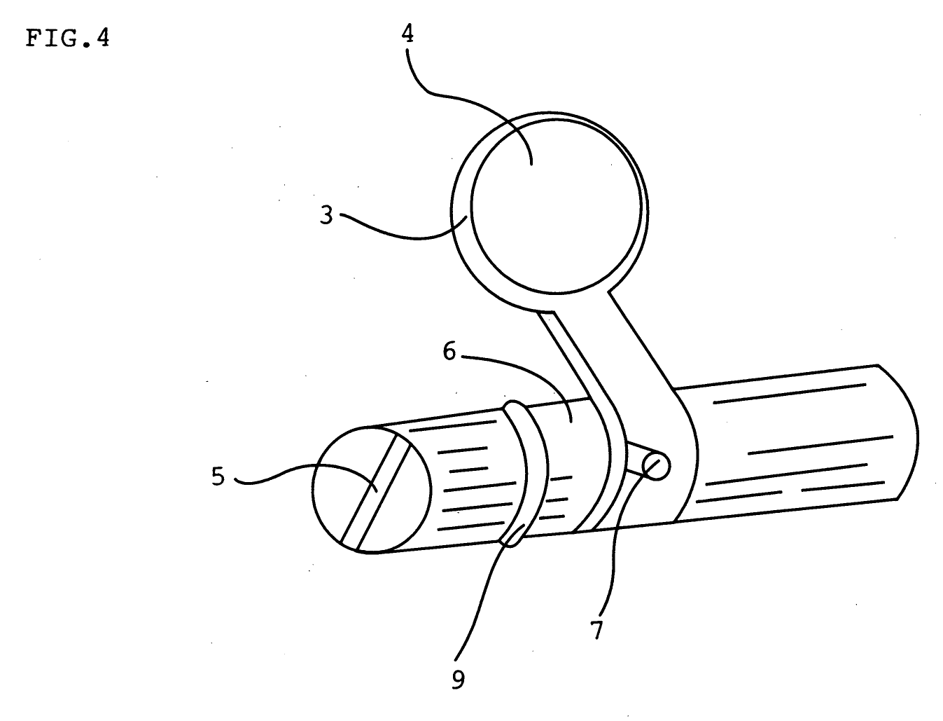

Referring to FIG. 4, the check valve of the present invention shows the hinge pin 6 assembly, a frontal view of retaining pin 7, showing it inserted into the valve door hinge assembly, as well as screwdriver slot 5 and o-ring 9 together with frontal view of valve door 3 and steel door cover 4.

I claim:

1. A shock responsive check valve for placement in a fluid conduit, comprising;
a conduit having a passage extending longitudinally therethrough, said passage providing an inlet end and an outlet end to said conduit;
a housing having an annular valve seat formed between the outlet and the valve chest;
a valve slidably mounted in said housing and adapted to reside in said annular valve seat;
said shock responsive check valve, conduit, housing, valve seat and valve mounted to the water supply in reverse, thereby facing the flow of water pressure;
a valve retainer connectably fastened above outer said housing and adapted to elevate said valve in distance away from valve seat;
a magnet means as valve retainer of said valve to secure valve in elevation a distance from valve seat;
a valve adapted to react to magnetic force, said valve provided with a steel plate connectably fastened to its opposite non-seatable side upwardly;
said valve to be magnetically elevated upwardly in distance from annular valve seat by the attraction between said magnet above said housing and said steel plate connectably to valve until the occurence of shock or earthquake breaks the contact;
said valve to reside in annular valve seat, stopping the flow of water upon shock or earthquake.

2. The shock responsive check valve of claim 1 wherein said valve position is resettable from closed position to open position by the use of a screwdriver;
means to reset valve position understood to be machining of hinge pin engagably connected to valve frame body whereby a thin rod is installed continuously through the hinge pin diameter and in to the valve body frame, whereby a hole is drilled through both hinge pin and valve body;
means to connect the valve body frame to the hinge pin to make accessible the resetting of valve from closed position to open position;
means to reset valve into open position provided by machining a screw slot in said hinge pin to make accessable for the use of a straight slot screwdriver to engage in said slot to turn in an anticlockwise manner to return valve to the open position.

3. The shock responsive check valve of claim 1 wherein the valve frame is machined by removing excess metal provided by original manufacturer thereby by said machining enabling the valve door to rise higher in elevation and providing an unobstructed flow of water into the conduit and by said elevation to facilitate the magnetic attraction between the steel plate connectably fastened to valve and the valve retainer understood to be a magnet.

4. The shock responsive check valve of claim 1 wherein said hinge pin is machined to install an o ring slidably inserted around its diameter, said o ring to provide a water tight seal between hinge pin and conduit.
